(19) United States
(12) Patent Application Publication
(10) Pub. No.: US 2009/0210516 A1
(43) Pub. Date: Aug. 20, 2009

(54) USING MOBILE DEVICE TO CREATE ACTIVITY RECORD

(75) Inventor: Steven G. Roskowski, Los Gatos, CA (US)

Correspondence Address: Workman Nydegger;1000 Eagle Gate Tower, 60 East South Temple, Salt Lake City, UT, 84111, US

(73) Assignee: CARRIER IQ, INC., Mountain View, CA (US)

(21) Appl. No.: 12/371,190

(22) Filed: Feb. 13, 2009

Related U.S. Application Data
(60) Provisional application No. 61/029,008, filed on Feb. 15, 2008.

(51) Int. Cl. G06F 15/173; G06F 15/16

(52) U.S. Cl. 709/219; 709/224

(57) ABSTRACT

A communication device and a data server record and collect events and event-related data to create an activity record. A user of the communication device may request that events and related data be recorded and collected using a configuration option on the communication device or through an interaction with the data server. Data are grouped into data sets and uploaded to the data server either automatically or upon user approval. The data server uses the uploaded data to create an activity record which the user may access through a website. The user uploads additional data which are associated with the activity record. In some instances, the data server embeds a link pointing to the additional data in an entry in the activity record corresponding to an event associated with the additional data.

### CROSS-REFERENCE TO RELATED APPLICATIONS

This application claims the benefit of U.S. Provisional Application Ser. No. 61/029,008, filed Feb. 15, 2008, which is incorporated herein by reference.

### BACKGROUND OF THE INVENTION

1. The Field of the Invention

The present invention relates generally to data collection. More particularly, embodiments of the invention relate to systems and methods for generating an activity record using a mobile device and a data server.

2. The Relevant Technology

A journal, log or diary (collectively “records” or “activity records”) can be useful for tracking activities, transactions, travels and other information important to an individual. Keeping a record of one's daily life in a personal journal provides a person with a tool with which to review times gone by, providing the person with a snapshot of their past thoughts, feelings, and life events. A transactional log may be used to record business and personal transactions and to verify that tasks are completed, projects are scheduled, bills are paid or collected and more. Another popular adaptation of such a record is for personal use as a time management tool, where a person may create to-do lists, schedule appointments and so on. Some journals and logs are even published, contain records of events, locations and other facts providing a basis for an author's literary work, or are used as evidence in judicial proceedings.

Many records are maintained using pen and paper, a computer, or some other mechanism. An increasingly popular form of journaling is the online blog, wherein an individual uses a computer to post commentary or news on a particular subject or on the individual's life and activities on the Internet. Others may record their thoughts, feelings, daily activities and other events on a personal computer or record a few bullet points in a calendar or in a calendar application of a computing device. Many other options for maintaining activity records exist, all of which may suffer from one or more flaws: they are inconvenient, inefficient or impractical for some people, often due to the level of effort and tools required to maintain the record.

Certain individuals that might otherwise benefit from maintaining an activity record forego these benefits when a record is not kept. For some, it may be difficult to maintain a record because they are forgetful and don't fill out the record with sufficient frequency. For others, a job or lifestyle may make it inconvenient, inefficient or impractical to continually keep pen and paper, a computer, or other conventional record-keeping implement on hand and in use.

What is needed, therefore, is a method and system for conveniently, efficiently, and practically recording activities, events and other information.

### BRIEF SUMMARY OF THE INVENTION

Embodiments of the present invention are directed to systems and methods for tracking activities performed with a mobile device. In particular, embodiments of the invention enable a mobile device to track events and event-related data (such as the time and location of the events) and to upload the data to a server, largely without user interaction. Moreover, the server can organize the data into an activity record that the user may view, manage and interact with. In this manner, the mobile device and the server are an efficient, convenient and practical vehicle for creating an activity record.

A user of a mobile device requests that events and event-related data be collected and data collection begins. The mobile device records events, such as receiving a phone call, as well as event-related data, such as when and where an event occurs. The data is usually grouped into data sets and uploaded to a data server. In one embodiment of the invention, a typical data set is all the events and event-related data collected during a twenty-four hour period. The mobile device may upload one data set at a time, or store and upload multiple data sets at the same time. The data server collects the uploaded data sets and uses them to create an activity record. The activity record may comprise a chronological representation of the events recorded by the mobile device, or the activity record may represent the events in some other manner, such as geographically. The user accesses the activity record stored on the data server through a website or some other interface and may interact with the record.

In some embodiments, the user uploads additional data to the data server and the data server associates the additional data with the activity record. For instance, if the user takes a photograph, the mobile device records that the user took a photograph, the user uploads the photograph to the data server, and the data server associates the photograph with the point in the activity record corresponding to the taking of the photograph. Alternatively, the photograph can be uploaded automatically as part of an event and placed in the activity record.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an operating environment in which events and event-related data may be recorded and uploaded to a server to create an activity record;

FIG. 2 depicts an exemplary segment of a data set recorded by a communication device;

FIG. 3a represents a voice note recorded by a data server which may be associated with an activity record;

FIG. 3b represents a photograph taken by a user which may be associated with an activity record;

FIG. 3c represents an SMS message uploaded from a communication device which me be associated with an activity record;

FIG. 4 illustrates a website which may be used to present an activity record to a user; and

FIG. 5 depicts a process for using a communication device and a data server to create an activity record with minimal user involvement.

### DETAILED DESCRIPTION OF THE PREFERRED EMBODIMENTS

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In general, embodiments of the invention are concerned with tracking data. More particularly, embodiments of the invention enable the use of a mobile device to record events and event-related data and the use of this data to create an activity record. Embodiments of the invention permit a user to maintain a log or record of events in a convenient, practical and efficient way.

A user of a mobile device requests that events and event-related data be collected by a data server and data collection begins. Alternately, data collection may be a default setting which is turned off only when the device user requests that data collection not occur. In yet another embodiment, a request from a server can initiate, pause, or stop data collection. The mobile device is configured to record events performed by the mobile device as well as event-related data. Typical events that the mobile device records include making or receiving a phone call; sending or receiving a message, including text, audio, photograph, video, email and multimedia messages; recorded voice data, voice messages, taking a photograph; recording the device's location; receiving and playing an FM or satellite radio broadcast; connecting to an 802.11 or Bluetooth access point; and using other device applications. The data most often related to an event include at least one of: the time, date and location of an event. However, other event-related data include a filename, a mobile device number (MDN) and a contact name. Commonly, the mobile device records events and provides a time, date and location stamp for each event. The events and event-related data can be recorded in sequence and can be stored on the mobile device.

Frequently, a sequence of recorded events and related data is grouped into one or more sessions or data sets. The grouping of the event sequence may be based on a period of time, the size of the data set and other factors. In a typical embodiment, an event sequence is grouped according to a period of time such as a day (e.g., twenty-four hours). In this embodiment, a session or data set comprises a sequence of all events and related data recorded by the mobile device during a day. Alternately, however, the event sequence can be divided based on size. For instance, a session may comprise an event sequence up to an arbitrarily chosen maximum size.

The mobile devices may be configured to store one or more data sets and upload the data sets to the data server. In one embodiment, the data sets are uploaded automatically without user intervention, while in other embodiments the mobile device presents a query to the user beforehand. When the mobile device is ready to upload one or more sessions to the data server, a pop-up screen or dialog may appear and present the user with various options. Three such options include (1) delete session, (2) defer and ask again and (3) upload now. The user interface may present the query every time a session is ready to upload, or the user may be permitted to select multiple sessions for deletion, a later reminder or upload all at once. In another embodiments, the uploading of sessions may occur automatically without user intervention. Uploads may also be configured to occur when the user is less likely to be using the device.

The data server collects the sessions and creates an activity record. As used herein, an “activity record” refers to a sequence of where a user was, what the user did, and when the user did it, and the like or any combination thereof. The data server organizes the collected events and event-related data to construct an activity record. The data server makes the activity record available on a website where it can be accessed via a web browser on the mobile device, a computer or some other device. The user then has the option to view, manage and interact with the collected data.

The data server supports attaching or associating additional data with the activity record, also known as “annotating” the record. For instance, the data server can associate an event object with an appropriate entry in the activity record. As used herein, the term “event object” refers to a data structure created as a result of an event and an “appropriate entry in the activity record” is an entry corresponding to the event which created the event object. A photograph is an event object created when a photograph is taken, a text message is an event object created when a text message is sent, an audio message is an event object created when a voice message is sent and so on.

A user may annotate an activity record by uploading an event object to the data server. When the event object is uploaded, the data server collects identifying information from the upload path of the event object. Event object identifying information includes a device identifier (such as an MDN) for the device from which the event object originates, a filename for the event object, and a time and location when the event object was created. The data server utilizes the identifying information to associate the event object with the appropriate entry in the activity record.

In one embodiment of the invention, the user takes a photograph with the mobile device and the photograph is associated with the activity record. The mobile device records the photograph-taking event and provides a time, date and location stamp for the event. The mobile device may additionally record a filename the photograph is saved under. A data set including the photograph-taking event and related data are uploaded to the data server and the user also uploads the event object (the actual photograph) to the data server. The user may upload the event object to a PC and then use the PC to upload the event object to the data server over an IP network, or the user may upload the event object via an over-the-air mechanism such as MMS. In either case, the data server locates identifying information from the event object's upload path, such as its filename, the time it was created and a device identifier for the device which created it. The data server uses the identifying information to locate the appropriate entry in the user's activity record to associate the photograph with. In a similar manner, the data server can associate notes and messages with the user's activity record. A “note” refers to an audio- or text-based message that the user creates for the specific purpose of annotating the activity record, while a “message” refers to any message sent to or received from another communication device which the user desires to associate with the activity record.

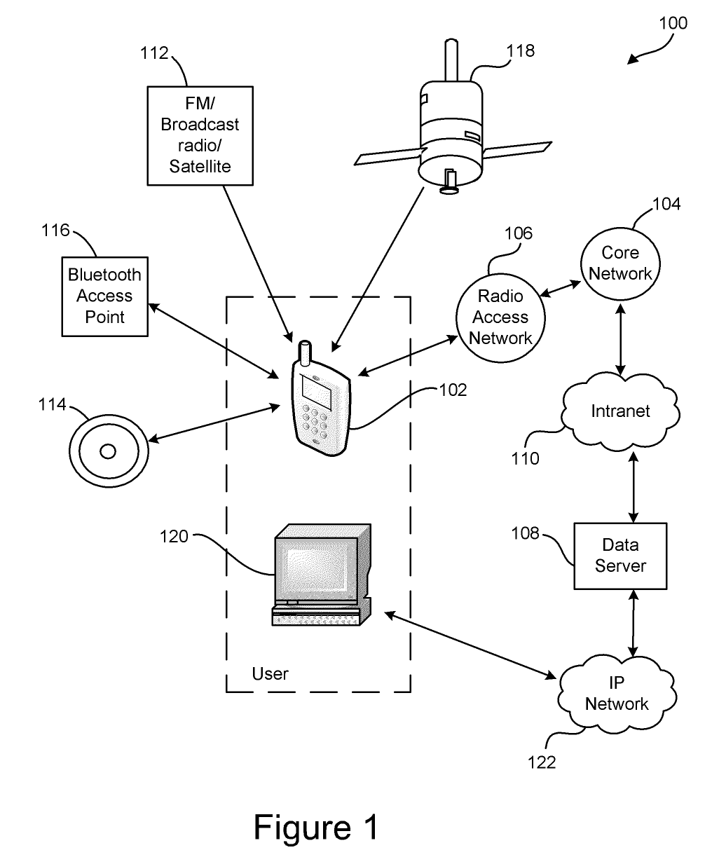

FIG. 1 illustrates an exemplary implementation of an operating environment, denoted generally at 100. Although this exemplary operating environment comprises multiple types of networks, including a cellular telephone network, wireless access points for 802.11 networks and Bluetooth networks, and broadcast networks such as FM radio or satellite radio, the invention may be employed in connection with any other type of network and associated devices that are effective in implementing or facilitating wireless communication or landline communication. While FIG. 1 depicts a cellular telephone and exemplary embodiments are directed to the use of cellular telephones in conjunction with the invention, the invention should not be construed to be limited to such devices. For example, PCs, televisions, landline telephones, cellular telephones, PDAs, smartphones, laptop computers and any other device suitably equipped to establish communication with a server and to record events and event-related data may be used to implement the methods of the invention. Accordingly, the scope of the invention should not be construed to be limited to the exemplary operating environment indicated in FIG. 1.

In the exemplary illustrated embodiment, the operating environment 100 includes one or more mobile communication devices 102 configured to communicate with one or more networks and/or network components. A communication device 102 is configured to communicate with a core network 104 via a radio access network 106. The core network 104 performs circuit and packet switching functions, thereby permitting a communication device 102 to initiate and receive voice calls, SMS, and other circuit switched data calls, and to access services such as WAP, MMS, and Internet. A communication device 102 may indirectly communicate with a data server 108 via an intranet network 110. In addition, a communication device 102 is configured to communicate with FM or satellite radio broadcast network 112, 802.11 wireless access points 114, and Bluetooth wireless access point 116. Mobile communication device 102 may also be configured to determine its geographical location using positioning techniques such as a global positioning system (GPS) or wireless-assisted GPS, for which it uses one or more satellites 118. Mobile communication devices 102 are further configured with event logging software that enables them, among other things, to record the events and event-related data occurring on the devices.

In the exemplary embodiment, the communication device 102 records events and related data occurring on the device, groups the recorded events and related data into data sets and periodically uploads the data sets to the data server 108. This process will hereinafter be referred to as “data collection,” “data collection service” or “the service.” Typically, the user affirmatively requests to participate in the data collection service through any one of a number of means. In one embodiment, the user interacts with a configuration option on the communication device 102 to request participation in the data collection service. For instance, a menu option on the communication device may permit the user to turn data collection on. In another embodiment, the user interacts with the server to request participation in the data collection service. For example, the user may call or send a message to a number associated with the server, or login to a website supported by the server to request participation in the service. The server may instead send a message to the user's device 102 instructing the user to reply to the message to participate in the data collection service. The server may alternately send a message to the user's device 102 with an embedded uniform resource indicator (URI), which, when invoked, takes the user to a website that allows the user to request participation in the data collection. Although typically the device and the server do not record, upload and collect data unless the user requests it, in other embodiments the communication device and the server automatically record, upload and collect data until the user affirmatively requests otherwise.

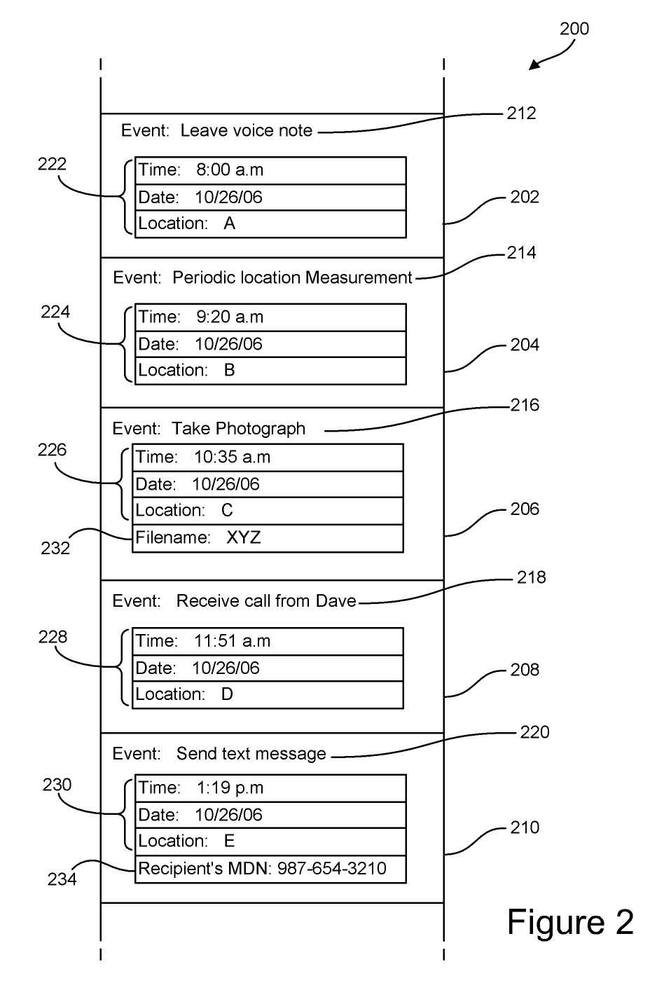

The sessions are uploaded to the data server 108 and the data server creates an activity record. The user may choose to annotate the activity record by attaching photographs, messages, notes and other event objects to the record, as will be described in more detail below with reference to FIGS. 2-4. The user may utilize a computing device 120 to communicate with the data server 108 over an IP network 122 and thereby view, manage and interact with the activity record created by the data server. Although illustrated as a personal computer in FIG. 1, the computing device 120 may be a laptop computer, cellular phone, smartphone, PDA and in general any device supporting a browser capable of viewing and interacting with a web site supported by the data server. In some embodiments, the communication device 102 may support a web browser, in which case the communication device 102 and the computing device 120 may be the same device.

With regard now to FIG. 2, an exemplary segment of a session recorded by the communication device is illustrated. The session segment comprises a sequence of entries 202, 204, 206, 208, 210 representing different events. Each entry comprises an event header 212, 214, 216, 218, 220 describing an event as well as a stamp 222, 224, 226, 228, 230 indicating the time, date and location of the respective events. In some embodiments of the invention, sessions are divided based on days, and it is unnecessary to date stamp each event since each event in the session occurs on the same date and the session itself may be date stamped.

The entries 202, 204, 206, 208, 210 depict exemplary events that may be recorded by a communication device 102. For instance, the user may desire to be reminded of what the user plans to do on a particular day. The user may call a phone number associated with the data server and leave a voice note (or the user may send a text message to the phone number). The communication device records the event 202 in the event header 212 and stamps the event with the time (8:00 a.m.), date (Oct. 26, 2006) and location (A) of the event. After the entry 202 is uploaded to the data server, the data server can associate the voice note left by the user with the entry in the activity record corresponding to entry 202.

The communication device 102 may be configured to automatically and periodically measure its location, whereupon a time, date and location stamp is provided, as shown in entry 204. Measurements may be taken using GPS satellites, Base Transceiver Stations with which the communication device communicates, or in some other way. In this case, the measurement occurs at 9:20 a.m., on Oct. 26, 2006 from location B. Although not shown in FIG. 2, the communication device may be configured to measures it's location every five minutes, in which case new entries for each measurement might appear in the data set.

At event 208, the communication device receives a phone call and identifies the caller in the event header 218. The caller may be identified by a device identifier, such as a mobile device number (MDN) or other calling party identifier associated with the caller's device. In the event the MDN is associated with a contact saved in the contact list of the communication device 102, the contact's name may be used to identify the caller, rather than using the caller's MDN. In the present embodiment, the call is received from “Dave,” which is recorded in the event header 218.

Events 206 and 210 produce event objects, similar to event 202, which may be attached to the activity record created by the data server 108. In event 206, the user takes a photograph using the mobile device and saves it on the communication device 102 under the filename XYZ. In a typical embodiment of the invention, the communication device 102 records the event in the event header 216, provides a time, date and location stamp 226, and may also record the filename 232. Consequently, if the user uploads the photograph to the data server 108, the data server can identify the filename of the uploaded photograph from the upload path and use the filename to locate the appropriate entry in the activity record with which to associate the photograph, e.g., the data server locates the event wherein a photograph with the filename XYZ was taken.

At event 210, the user creates a text message and sends it to a recipient, as recorded in the event header 220. Typically, the text messages sent to and from the communication device 102 are short message service (SMS) messages. The communication device records the time, date and location 230 of the event and may also record the recipient's MDN 234. In this case, the recipient to which the user sends the text message has an MDN of 987-654-3210. The user may upload the text message to the data server 108, and the data server locates identification information in the uploaded text message to associate the text message with the appropriate entry in the activity record created by the data server. Other messages sent to and from the communication device 102 may similarly be uploaded to the data server 108 and used to annotate the activity record. The messages may be an integral part of the event and attached to the event automatically.

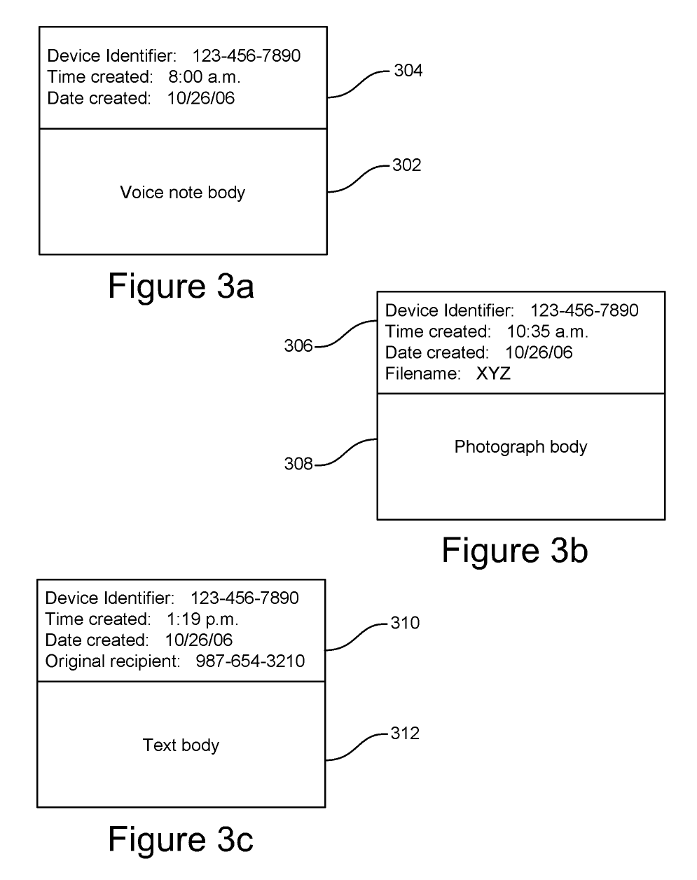

FIGS. 3a, 3b and 3c illustrate different event objects which may be associated with the activity record. In FIG. 3a, a voice note created by the event 202 is depicted. The user calls in to a number associated with the data server 108 to leave the voice note. The data server records the voice note, creating a file containing the body of the voice note 302 and attaching a header 304 with sufficient information to identify the voice note. The header may indicate the time and date the voice note is created as well as the MDN for the communication device from which the voice note is received. In this case, the voice not is received from the communication device 102, having an MDN of 123-456-7890. Since the data server may store activity records for multiple users, the data server can use the MDN to locate the activity record corresponding to the user that just left the voice note. Using the time the voice note is created, the data server can locate the appropriate entry in the activity record with which to associate the voice note.

The photograph taken at event 206 and uploaded to the data server 108 is illustrated in FIG. 3b. In the exemplary embodiment, the photograph is uploaded to the data server using HTTP. Typically when the photograph is created, the communication device 102 embeds identifying information in a header 306 attached to the photograph body 308, such as the time and date the photograph is created, as well as the photograph's filename. When the user uploads the photograph directly from the communication device to the data server using the MMS protocol or some other mechanism, the data server 108 captures the device identifier and saves this with the identifying information. Alternately, the user may upload the photograph to a PC 120 and then upload the photograph from the PC to the data server over the IP network 122. In this case, the user typically logs in to a user account prior to uploading the photograph to the data server. The user's device identifier is associated with the user account, thereby providing a device identifier for the uploaded photograph. As with the voice note, the data server 108 utilizes the identifying information to associate the photograph with the appropriate entry in the user's activity record.

At event 210, the user creates and sends a text message to a recipient. The user may desire to associate the text message with the user's activity record and does so by forwarding the text message to a number associated with the data server 108. The text message comprises a header 310 with identifying information, such as the time and date the text message is created, a device identifier for the user's device, and possibly even a device identifier for the original recipient of the text message. The text message further comprises a payload 314 containing the body of the text message. The information contained in the header 310 is used to associate the text message with its corresponding entry in the user's activity record.

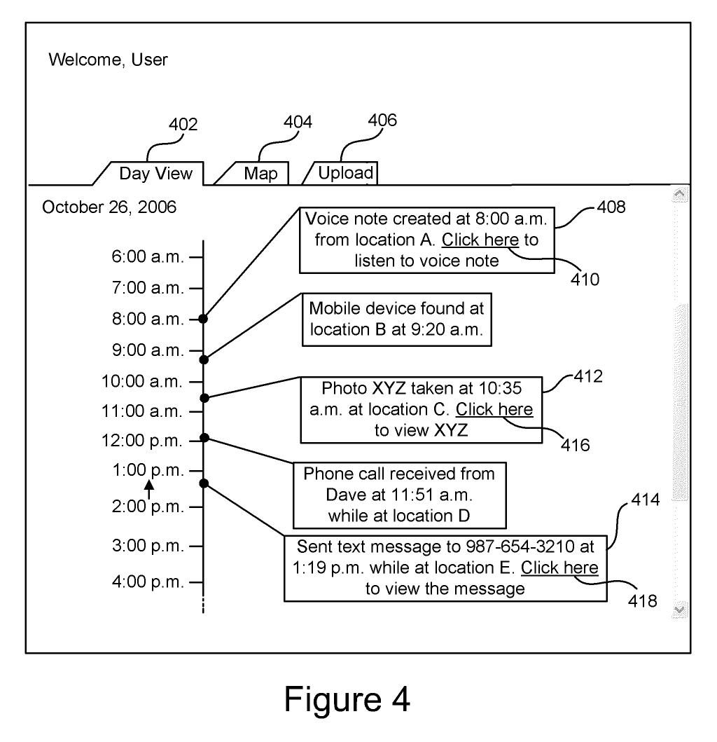

Turning attention now to FIG. 4, an exemplary embodiment of an annotated activity record that may be presented to a user on a website is illustrated. FIG. 4 is intended only to illustrate one way in which an activity record may be presented to a user and should not be construed to limit the invention in any way. The user accesses a website associated with the data server 108 using a computing device 120. Various tabs 402, 404, 406 present the user with different options, modalities and applications with regard to uploaded data sets. In the embodiment shown, the user selects a “day view” tab 402 which presents an activity record constructed from the events recorded in the session segment of FIG. 2. Rather than viewing the activity record chronologically, as shown, the user may select the “map” tab 404 and view the different events in a geographic arrangement. The data server 108 may present the user with other tabs, which when selected, present the activity record to the user in different manners.

The user may desire to upload event objects and associate them with the activity record using the “upload” tab 406. The data server 108 associates an event object with a corresponding entry in the user's activity record, as previously discussed, by comparing event object identifying information to the information stored in the different entries in the activity record. In the embodiment shown, the data server embeds a link in a corresponding entry in the user's activity record which points to the event object. Thus, the voice note created by the user at 8:00 a.m. is associated with entry 408 and the user may listen to the voice note by clicking on the embedded link 410. Similarly, the photograph is associated with entry 412 and the text message is associated with entry 414 and either one may be viewed by clicking on the respective embedded links 416 and 418.

In other embodiments of the invention, photographs can be displayed as thumbnails in the activity record. Also, a mobile device may record telephone conversations automatically. The recorded voice data can then be uploaded as an event as described above.

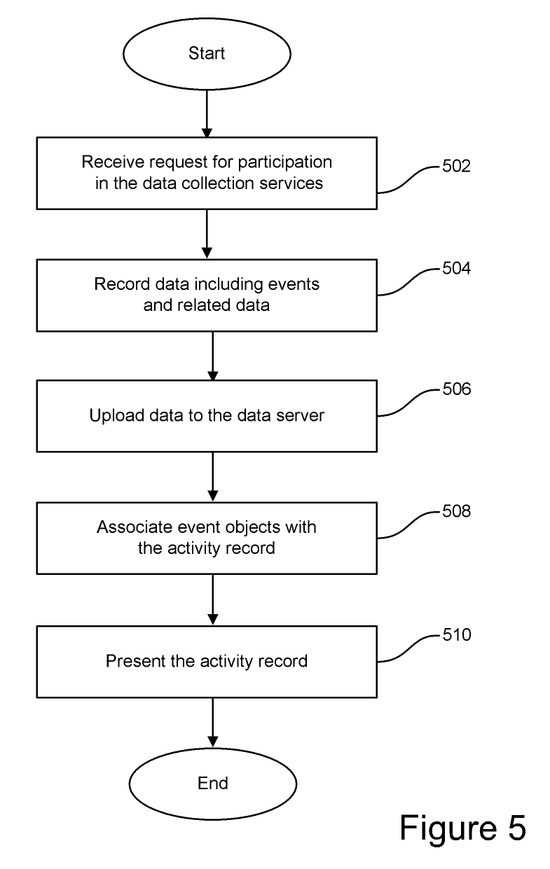

FIG. 5 is a flowchart illustrating an exemplary method of creating an activity record. The process begins when the data server 108 receives 502 a request from a user to participate in the data collection services described herein. Following the request, the communication device 102 begins recording 504 data, including event and event-related data. In embodiments where participation in the data collection services is the default configuration for a mobile device (e.g., an “opt-out” model), it is not necessary to receive a request from a user prior to recording data.

The communication device records data and may group the data into data sets. Each data set may be uploaded when complete, or multiple sessions may be stored on the communication device prior to being uploaded. Hence, if a communication device is out of network coverage when a data set is ready to be uploaded, the data set may be stored on the device until back in the network. The data is uploaded 506 to the data server over a data channel and may be done automatically, or in response to user input. For instance, users enrolled in wireless service plans with unlimited data transfer are typically unconcerned with data traffic and may prefer to have their data uploaded seamlessly and without user intervention or activity. Other users concerned with data traffic may prefer to be queried prior to the upload of their data. In this case, a pop-up screen or dialog may appear when the device is ready to upload data. This may occur every time a data set is ready to be uploaded, or after multiple data sets have accumulated on the device. In a typical embodiment, the user has the option to (1) delete a data set, (2) be reminded later and (3) upload the data set now. Moreover, when multiple data sets have accumulated on the device, the user may be presented with a list of the data sets and be able to select one or multiple data sets for deletion, a later reminder or immediate upload. In another embodiment of the invention, the communication device 102 may upload a data set when the user specifically requests access to information contained in the data set

The data uploaded to the data server 108 can be arranged as an activity record and presented 510 to the user on a website or through some other mechanism. Optionally, the user may desire to associate 508 event objects with the activity record. The user may upload event objects to the data server at any time after they have been created. For instance, the user may use a phone to take a photograph during the day and upload it to the data server 108 shortly after taking it. If the phone is configured to upload event and event-related data at the end of each day, the data server 108 will not be able to associate the photograph with the activity record until the data set is uploaded. Alternately, the user may upload the photograph after the event and event-related data are uploaded.

Advantageously, the system 100 enables a convenient, efficient and practical method for creating an activity record. Once a user requests to participate in the data collection service, event and event-related data may be recorded and collected in a manner transparent to the user. The user optionally may associate notes, messages, photographs, and other data with the activity record generated by the data server. Further, the user may view, manage and interact with the activity record on a website supported by the data server.

It should be understood that this and other arrangements and processes described herein are set forth for purposes of example only, and other arrangements and elements (e.g., machines, interfaces, functions, orders of elements, etc.) can be added or used instead and some elements may be omitted altogether. Further, those skilled in the art will appreciate that many of the elements described herein are functional entities that may be implemented as discrete components or in conjunction with other components, in any suitable combination and location, and by software, firmware and/or hardware.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a communication system, a method for creating an activity record, the method comprising:
recording data at a device, the data including one or more events and event-related data that describe activities of a user;
uploading the data to a server, wherein the server organizes the data based the event related data; and
generating an activity record using the data that can be presented to a user, wherein the activity record represents at least a partial log of the activities of the user.

2. The method of claim 1, wherein event-related data comprise one or more of:
a time an event occurs;
a date the event occurs;
a location of the device when the event occurs;
a filename of an event object associated with the event;
a mobile device number (MDN); and
a contact name.

3. The method of claim 2, wherein generating an activity record using the data comprises creating an entry for each of the one or more events describing where and when an event occurred.

4. The method of claim 3, further comprising presenting the activity record on a website, wherein the website is accessed by the device or using another device.

5. The method of claim 3, wherein the one or more events comprise at least one of:
making or receiving a phone call;
sending or receiving a message;
taking a photograph;
recording a device location;
receiving and playing a broadcast;
connecting to an 802.11 or Bluetooth access point; and
using a device application.

6. The method of claim 5, wherein the location of the mobile device is recorded periodically and independently of other events.

7. The method of claim 5, further comprising uploading an event object to the server and associating the event object with an entry corresponding to an event which created the event object.

8. The method of claim 7, wherein associating an event object with an entry corresponding to an event which created the event object comprises:
comparing identification information recorded at the time the event occurs to identification information attached to the event object when uploaded to the server; and
embedding a link to the event object in the entry corresponding to the event which created the event object.

9. The method of claim 8, wherein identification information comprises one or more of the time the event object is created, the MDN of the device from which the event object is uploaded and a filename of the event object.

10. The method of claim 7, wherein an event object comprises one or more of a note, a photograph, recorded voice, and a message.

11. The method of claim 10, wherein a message comprises one or more of:
a short message service message;
an audio message;
a photograph message;
a video message;
a multimedia messaging service message; and
an email message.

12. The method of claim 1, further comprising recording and uploading the data in response to a user's interaction with a configuration option on a mobile device affirmatively requesting that the data be recorded and uploaded.

13. The method of claim 1, further comprising recording and uploading the data in response to a user's interaction with the server affirmatively requesting that the data be recorded and uploaded.

14. The method of claim 1, further comprising, prior to uploading the data to a server, grouping the data into one or more data sets.

15. The method of claim 14, wherein a data set comprises all the events and event-related data recorded during a time period.

16. The method of claim 14, wherein the one or more data sets are uploaded automatically without user intervention.

17. The method of claim 14, wherein a device queries a device user prior to uploading the one or more data sets.

18. The method of claim 17, further comprising the user selecting at least one data set for deletion or uploading.

19. The method of claim 17, further comprising the user selecting two or more data sets for deletion or uploading at the same time.

20. A method for creating an activity log for a user of a mobile device, the method comprising:
receiving data from a mobile device at a server, wherein the data includes event-related data describing one or more events that occurred on the mobile device;
recording the event-related data in an activity log at a server computer; wherein the event-related data is configured for display in the activity log; and
generating an entry in the activity log for each event.

21. The method of claim 20, wherein an entry in the activity record comprises a description of each event and the time and location that each event occurred.

22. The method of claim 21, further comprising receiving an access request for the activity record from a device.

23. The method of claim 20, further comprising uploading an event object to the server, wherein the event object associated with an event comprises one or more of a note, a message or a photograph.

24. The method of claim 20, further comprising uploading an event object associated with an event from a mobile device to a computing device and from the computing device to the server.

25. The method of claim 23, further comprising using identifying information attached to the event object with identifying information from the activity record to associate the event object with a particular entry in the activity record corresponding to a particular event which created the event object.

26. The method of claim 20, further comprising generating a website wherein the activity record may be viewed, managed and interacted with by a user.

27. The method of claim 20, wherein an event includes one or more of making or receiving a phone call;
sending or receiving a message;
taking a photograph;
recording a device location;
receiving and playing a broadcast;
connecting to an 802.11 or Bluetooth access point; and
using a device application; and
wherein event-related data includes one or more of:
a title of an event;
a file name of an event object;
a link to an event object;
a time of the event
a location of the event;
a mobile number of a caller
a mobile number of a callee;
a text message;
a voice message; and
a recorded telephone call.

28. The method of claim 20, wherein receiving data from a mobile device further comprises one or more of:
receiving data that includes event-related data for multiple events;
receiving input that prevents at least one event and corresponding event-data from being received; and
receiving input from a user allowing collection of the data at the mobile device.
